(19) United States
(12) Patent Application Publication
(10) Pub. No.: US 2015/0137877 A1
(43) Pub. Date: May 21, 2015

(54) BIAS CIRCUIT USING NEGATIVE VOLTAGE

(71) Applicant: Electronics and Telecommunications Research Institute, Daejeon (KR)

(72) Inventors: Yun Ho CHOI, Daejeon (KR); Youn Sub NOH, Daejeon (KR); Hong Gu JI, Daejeon (KR); Jin Cheol JEONG, Daejeon (KR); In Bok YOM, Daejeon (KR)

(21) Appl. No.: 14/308,931

(22) Filed: Jun. 19, 2014

(30) Foreign Application Priority Data
Nov. 21, 2013 (KR) 10-2013-0142291

(51) Int. Cl. G05F 3/16

(52) U.S. Cl. CPC G05F 3/16
USPC 327/537

(57) ABSTRACT

Provided is a bias circuit. The bias circuit includes: a first resistor connected between a ground terminal and a first node; a first bias transistor having a drain connected to the first node and a source connected to a second node; a second bias transistor having a drain connected to the second node and a source connected to a negative voltage terminal; a third bias transistor having a drain connected to the ground terminal and a source connected to a third node; and a second resistor connected between the third node and the negative voltage terminal, wherein a gate of the first bias transistor is connected to the second node; a gate of the second bias transistor is connected to the negative voltage terminal; a gate of the third bias transistor is connected to the first node; and a gate bias voltage signal is outputted through the third node.

### CROSS-REFERENCE TO RELATED APPLICATIONS

This U.S. non-provisional patent application claims priority under 35 U.S.C. §119 of Korean Patent Application No. 10-2013-0142291, filed on Nov. 21, 2013, the entire contents of which are hereby incorporated by reference.

### BACKGROUND OF THE INVENTION

The present invention disclosed herein relates to a bias circuit, and more particularly, to a bias circuit using negative voltage.

In a transistor, a temperature change accompanies a performance change. In general, a transistor has characteristics that an operating point current decreases by a transconductance Gm, which decreases as a temperature rises. Therefore, a bias circuit that increases a gate voltage of a transistor when a temperature rises is necessary.

As a compensation technique for a temperature change, there is a temperature compensation circuit using a threshold voltage of a diode, which decreases when a temperature rises. However, such a temperature compensation circuit may not expect compensation effect for a change in supply power.

In general, a transistor, for example, a type of a field effect transistor (FET), may have different threshold voltage values depending on a position of a wafer during manufacturing processes. Accordingly, in order to allow transistors manufactured from a wafer to operate under the same condition, it is required that different gate voltages be supplied to the transistors. Due to this, a bias circuit is not built in a microwave monolithic integrated circuit (MMIC). A gate voltage of a transistor is applied as a desired voltage to a transistor by using several devices outside. Accordingly, since additional processes and components are required, there are limitations in reducing components production costs.

### SUMMARY OF THE INVENTION

The present invention provides a bias circuit supplying stable voltage and current to a transistor under a changing condition of temperature and supply voltage.

Embodiments of the present invention provide bias circuits including:

a first resistor connected between a ground terminal and a first node; a first bias transistor having a drain connected to the first node and a source connected to a second node; a second bias transistor having a drain connected to the second node and a source connected to a negative voltage terminal; a third bias transistor having a drain connected to the ground terminal and a source connected to a third node; and a second resistor connected between the third node and the negative voltage terminal, wherein a gate of the first bias transistor is connected to the second node; a gate of the second bias transistor is connected to the negative voltage terminal; a gate of the third bias transistor is connected to the first node; and a gate bias voltage signal is outputted through the third node.

In some embodiments, the bias circuits may further include a bias resistor connected to the third node.

In other embodiments, the first to third bias transistors may be depletion transistors.

In still other embodiments, a first bias current flowing in the first resistor may be controlled by the first and second bias transistors.

In even other embodiments, a gate voltage of the third bias transistor may be controlled by the first resistor and the first bias current.

In yet other embodiments, a second bias current flowing in the second resistor may be controlled by the third bias transistor.

In further embodiments, the gate bias voltage may be controlled by the second resistor and the second bias current.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a circuit diagram illustrating a general bias circuit supplying a fixed gate bias voltage;

FIG. 2 is a graph illustrating a gate bias voltage and an operating point current according to a temperature in an amplifier of FIG. 1;

FIG. 3 is a graph illustrating a gate bias voltage and an operating point current according to a negative voltage in an amplifier of FIG. 1;

FIG. 4 is a circuit diagram illustrating a bias circuit according to an embodiment of the present invention;

FIG. 5 is a graph illustrating a relationship between first and second bias currents of FIG. 4;

FIG. 6 is a graph illustrating changes in gate bias voltage and operating point current of FIG. 4 according to a temperature; and

FIG. 7 is a graph illustrating changes in gate bias voltage and operating point current of FIG. 4 according to a negative voltage.

### DETAILED DESCRIPTION OF PREFERRED EMBODIMENTS

Preferred embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art.

Hereinafter, a bias circuit is used as one example of an electronic device to describe features and functions of the present invention. However, those skilled in the art can easily understand other advantages and performances of the present invention according to the descriptions. The present invention may be embodied or applied through other embodiments. Besides, the detailed description may be amended or modified according to viewpoints and applications, not being out of the scope, technical idea and other objects of the present invention.

Hereinafter, it will be described about an exemplary embodiment of the present invention in conjunction with the accompanying drawings.

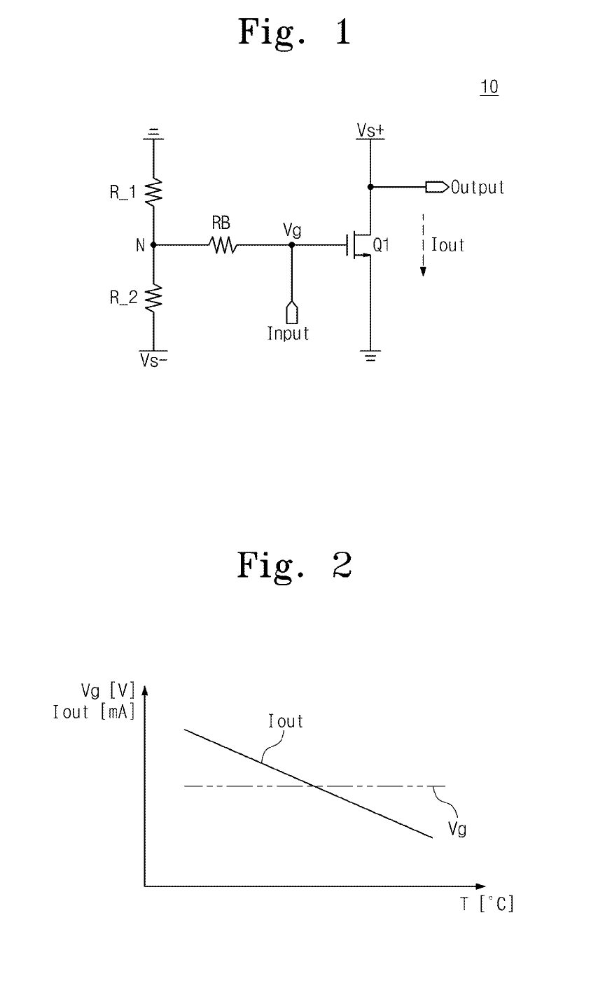

FIG. 1 is a circuit diagram illustrating a general bias circuit supplying a fixed gate bias voltage. Referring to FIG. 1, an amplifier 10 may include a bias circuit having a first resistor R_1 and a second resistor R_2. The amplifier 10 may generate an output signal Output by amplifying an input signal Input through an amplifier transistor Q1.

The first resistor R_1 and the second resistor R_2 may supply a gate bias voltage Vg to the amplifier transistor Q1. The first resistor R_1 may be connected to a ground terminal The second resistor R_2 may be connected to a negative voltage Vs− terminal. The gate bias voltage Vg is determined depending on the first resistor R_1 and the second resistor R_2. Since a ratio of the first resistor R_1 and the second resistor R_2 is constant according to a temperature, the gate bias voltage Vg may have a constant predetermined value according to a temperature. The gate bias voltage Vg may be delivered to the amplifier transistor Q1 through a bias resistor RB. The bias resistor RB may be used to prevent the leakage of an input signal Input inputted to the amplifier transistor Q1. For example, if a size of the input signal Input is ‘100’, the bias resistor RB is configured to deliver a signal corresponding to ‘99’ of the size of the input signal Input to the amplifier transistor Q1 and deliver a signal corresponding to ‘1’ of the size of the input signal Input to a bias circuit. The bias resistor RB is replaced with an inductor.

The amplifier transistor Q1 may be a depletion transistor. The depletion transistor may have a value of a negative threshold voltage Vth. In the amplifier transistor Q1, a transconductance Gm decreases when a temperature rises. Once the transconductance Gm decreases, an operating point current Iout of the amplifier transistor Q1 decreases while the gate bias voltage Vg is constant. If an operating point current Iout of the amplifier transistor Q1 decreases, a gain of the amplifier 10 decreases. Additionally, if the negative voltage Vs− changes, the gate bias voltage Vg changes. If the gate bias voltage Vg changes, the operating point current Iout of the amplifier transistor Q1 changes simultaneously.

Accordingly, a bias circuit compensating a gain reduction phenomenon of the amplifier 10 at high temperature by increasing the operating point current Iout of the amplifier transistor Q1 when a temperature rises is required. Moreover, a bias circuit maintaining the constant operating point current Iout of the amplifier transistor Q1 regardless of a change of the negative voltage Vs− is required.

FIG. 2 is a graph illustrating a gate bias voltage and an operating point current according to a temperature in the amplifier of FIG. 1. Referring to FIG. 2, the gate bias voltage Vg may have a constant value regardless of temperature. The gate bias voltage Vg may be determined by the first resistor R_1 and the second resistor R_2 according to a voltage divider rule. Since a ratio of the first resistor R_1 and the second resistor R_2 is constant regardless of temperature, the gate bias voltage Vg may have a constant value.

The operating point current Iout of the amplifier transistor Q1 may decrease as a temperature rises. A constant gate bias voltage Vg may be applied to a gate of the amplifier transistor Q1 according a temperature rise. The transconductance Gm of the amplifier transistor Q1 may decrease as a temperature rises. As a result, if the gate bias voltage Vg is constant as a temperature rises, the operating point current Iout of the amplifier transistor Q1 decreases as a temperature rises.

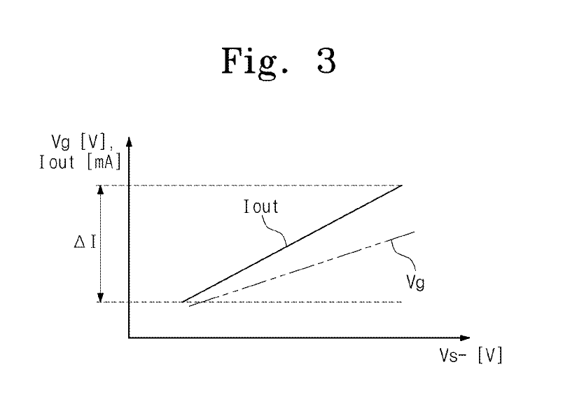

FIG. 3 is a graph illustrating a gate bias voltage and an operating point current according to a negative voltage in the amplifier of FIG. 1. Referring to FIG. 3, the gate bias voltage Vg and the operating point current Iout may change when a negative voltage Vs− changes. The gate bias voltage Vg may be determined by the first resistor R_1 and the second resistor R_2. Accordingly, the gate bias voltage Vg may increase as the negative voltage Vs− increases. The operating point current Iout of the amplifier transistor Q1 may change according to the gate bias voltage Vg. If a temperature is constant, the operating point current Iout of the amplifier transistor Q1 may increase in proportion to the increase of the gate bias voltage Vg. As a result, the operating point current Iout of the amplifier transistor Q1 may change linearly in proportion to a dynamic range of the negative voltage Vs−. The operating point current Iout of the amplification transistor Q1 changes by a current variation ΔI.

Accordingly, a bias circuit compensating a gain reduction phenomenon of the amplifier 10 at high temperature by increasing the operating point current Iout of the amplifier transistor Q1 when a temperature rises is required. Moreover, a bias circuit maintaining the constant operating point current Iout of the amplifier transistor Q1 regardless of a change of the negative voltage Vs− is required.

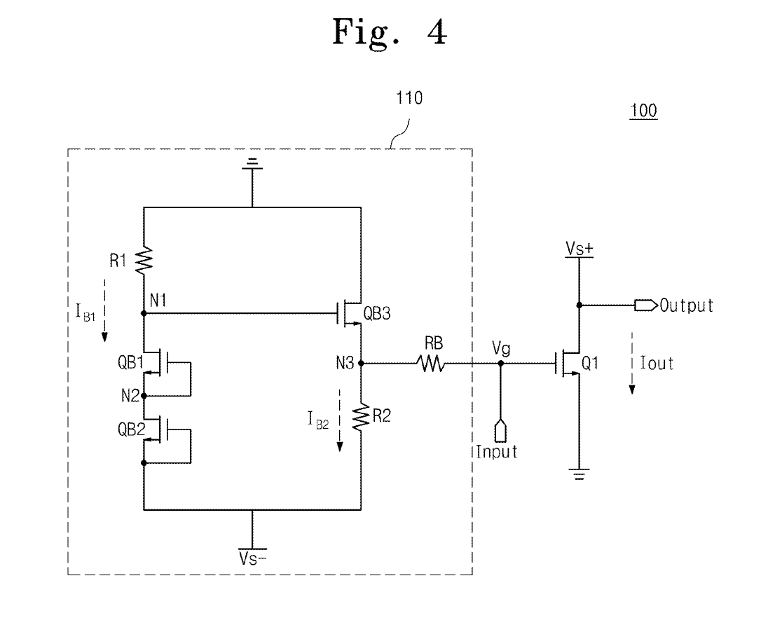

FIG. 4 is a circuit diagram illustrating a bias circuit according to an embodiment of the present invention. An amplifier 100 includes a bias circuit 110 and an amplifier transistor Q1. The amplifier transistor Q1 may be driven by a positive voltage Vs+.

The bias circuit 110 may supply a gate bias voltage Vg to the amplifier transistor Q1 to allow a constant operating point current Iout to flow regardless of a change of a temperature and a negative voltage Vs−. The bias circuit 110 includes bias transistors QB1, QB2, and QB3 and resistors R1, R2, and RB. The bias transistors QB1, QB2, and QB3 and the amplifier transistor Q1 may be depletion transistors having a negative threshold voltage Vth. Hereinafter, the case that the bias transistors QB1, QB2, and QB3 and the amplifier transistor Q1 are depletion transistors having a negative threshold voltage Vth will be described.

A depletion transistor having a negative threshold voltage Vth may show characteristics that its gain is reduced by a transconductance Gm that decreases as a temperature increases. Additionally, a general transistor may show characteristics that an operating point current drastically changes according to a change in gate voltage.

Referring to FIG. 4 again, the first resistor R1 may be connected between the ground terminal and a first node N1. The drain of the first bias transistor QB1 may be connected to the first node N1. The source of the first bias transistor QB1 may be connected to a second node N2. The drain of the second bias transistor QB2 may be connected to the second node N2. The source of the second bias transistor QB2 may be connected to a terminal of the negative voltage Vs−. The gate and the source of the first bias transistor QB1 may be connected to each other. The gate and the source of the second bias transistor QB2 may be connected to each other. The first and second bias transistors QB1 and QB2 may have a negative threshold voltage Vth. Accordingly, if the gate and the source are connected, the first and second bias transistors QB1 and QB2 may be turned on always. A first bias current I_{B1} may be determined by the first and second bias transistors QB1 and QB2.

Accordingly, a voltage of the first node N1 may be determined by the first resistor R1 and the first bias current I_{B1}.

The gate of the third bias transistor QB3 may be connected to the first node Ni. The drain of the third bias transistor QB3 may be connected to the ground terminal. The source of the third bias transistor QB3 may be connected to a third node N3. The second resistor R2 may be connected between the third node N3 and the terminal of the negative voltage Vs−. The third bias transistor QB3 may be driven according to a voltage of the first node Ni. A second bias current I_{B2} may be determined by the third bias transistor QB3. Accordingly, a voltage of the third node N3 may be determined by the second resistor R2 and the second bias current I_{B2}. A voltage of the third node N3 is a gate bias voltage Vg supplied to the gate of the amplifier transistor Q1. Accordingly, the gate bias voltage Vg is controlled according to a change of the first and second bias currents I_{B1} and I_{B2}. The gate bias voltage Vg may be supplied to the gate of the amplifier transistor Q1 through the bias resistor RB. The bias resistor RB may be used to prevent the leakage of the input signal Input inputted to the amplifier transistor Q1. The bias resistor RB may be replaced with an inductor.

If a temperature rises, the transconductance Gm of the transistors QB1, QB2, QB3, and Q1 may decrease. Accordingly, a current flowing in the transistors QB1, QB2, QB3, and Q1 may decrease. On the contrary, if a temperature drops, the transconductance Gm of the transistors QB1, QB2, QB3, and Q1 may increase. Accordingly, a current flowing in the transistors QB1, QB2, QB3, and Q1 may increase.

First, as a temperature rises, the first bias current I_{Bi} flowing in the first and second bias transistors QB1 and QB2 may decrease. Accordingly, a voltage of the first node N1 determined by the first resistor R1 and the first bias current I_{B1} may increase. Once a voltage of the first node N1 increases, the second bias current I_{B2} flowing in the third bias transistor QB3 may increase. Once the second bias current I_{B2} increases, a voltage of the third node N3 determined by the second resistor R2 and the second bias current I_{B2} may increase. Once a voltage of the third node N3 increases, that is, the gate bias voltage Vg increases, the operating point current Iout flowing in the amplifier transistor Q1 may increase. Accordingly, the operating point current Iout decreasing when a temperature rises may be compensated by an operation of the bias circuit 110.

On the contrary, if a temperature drops, the first bias current Iₘ flowing in the first and second bias transistors QB1 and QB2 may increase. Accordingly, a voltage of the first node N1 determined by the first resistor R1 and the first bias current I_{B1} may decrease. Once a voltage of the first node Ni decreases, the second bias current I_{B2} flowing in the third bias transistor QB3 may decrease. Once the second bias current I_{B2} decreases, a voltage of the third node N3 determined by the second resistor R2 and the second bias current I_{B2} may decrease. Once a voltage of the third node N3 decreases, that is, the gate bias voltage Vg decreases, the operating point current Iout flowing in the amplifier transistor Q1 may decrease. Accordingly, the operating point current Iout increasing when a temperature drops may be compensated by an operation of the bias circuit 110.

As a result, the bias circuit 110 may supply the gate bias voltage Vg that changes according to a temperature change to the gate of the amplifier transistor Q1. Then, the operating point current Iout of the amplifier transistor Q1 may be maintained constantly regardless of a temperature change. Accordingly, the amplifier 100 may maintain constant performance regardless of a temperature change.

When the negative voltage Vs− changes, the bias circuit 110 may reduce the fluctuation of the operating point current Iout of the amplifier transistor Q1. If there is a fluctuation of the negative voltage Vs−, it is assumed that a temperature is constant.

First, when the negative voltage Vs− drops, the second bias current I_{B2} may increase linearly with respect to the negative voltage Vs− by the third bias transistor QB3. Once the second bias current I_{B2} increases, the gate bias voltage Vg determined by the second resistor R2 and the second bias current I_{B2} may drop at a rate lower than a drop rate of the negative voltage Vs−.

On the contrary, when the negative voltage Vs− rises, the second bias current I_{B2} may decrease linearly with respect to the negative voltage Vs− by the third bias transistor QB3. Once the second bias current I_{B2} decreases, the gate bias voltage Vg determined by the second resistor R2 and the second bias current I_{B2} may rise at a rate lower than a rise rate of the negative voltage Vs−.

As a result, the gate bias voltage Vg may be controlled to change at a rate lower than a change rate of the negative voltage Vs− through the bias circuit 110. The operating point current Iout of the amplifier transistor Q1 may change in proportion to the gate bias voltage Vg. Accordingly, when the negative voltage Vs− changes, the bias circuit 110 may control the operating point Iout of the amplifier transistor Q1 to change with a smaller fluctuation than the negative voltage Vs−.

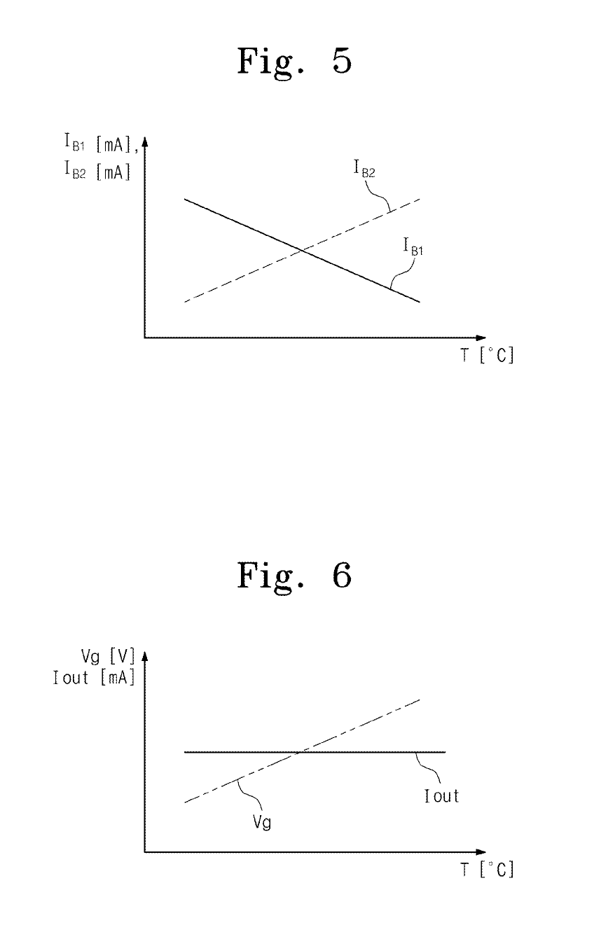

FIG. 5 is a graph illustrating a relationship between the first and second bias currents of FIG. 4. Referring to FIG. 5, the first bias current I_{B1} decreases as a temperature rises. The first bias current I_{B1} may be determined by the first and second bias transistors QB1 and QB2. The transconductance Gm of the first and second bias transistors QB1 and QB2 may decrease as a temperature rises. Accordingly, the first bias current I_{B1} may decrease as the transconductance Gm of the first and second bias transistors QB1 and QB2 decreases. When the first bias current I_{B1} decreases, the second bias current I_{B2} may increase. A voltage of the first node N1 determined by the first resistor R1 and the first bias current Iₘ may increase.

Once the voltage of the first node N1 increases, the second bias current I_{B2} flowing in the third bias transistor QB3 may increase. As a result, if a temperature rises, the first bias current I_{B1} may decrease and accordingly, the second bias current I_{B2} may increase.

FIG. 6 is a graph illustrating changes in gate bias voltage and operating point current of FIG. 4 according to a temperature. Referring to FIG. 6, a gate bias voltage Vg may increase as a temperature rises. The gate bias voltage Vg may be determined by the second resistor R2 and the second bias current I_{B2}. As shown in FIG. 5, the second bias current I_{B2} may increase as a temperature rises. Accordingly, when the second bias current I_{B2} increases as a temperature rises, the gate bias voltage Vg may increase due to the temperature rise.

The operating point current Iout of the amplifier transistor Q1 may be constant regardless of a temperature change. In general, when the gate bias voltage Vg is constant, the operating point current Iout of the amplifier transistor Q1 may decrease as a temperature rises. Accordingly, when the gate bias voltage Vg increases as a temperature rises, the decrease of the operating point current Iout of the amplifier transistor Q1 may be compensated. As a result, the operating point current Iout of the amplifier transistor Q1 may be maintained constantly by the bias circuit 110 regardless of a temperature change.

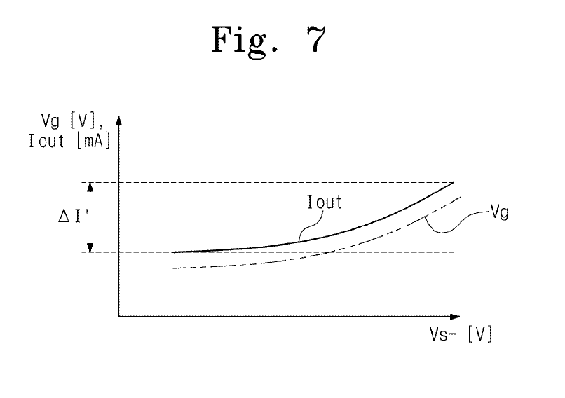

FIG. 7 is a graph illustrating changes in gate bias voltage and operating point current of FIG. 4 according to a negative voltage. The gate bias voltage Vg may be determined by the second resistor R2 and the second bias current I_{B2}. The second bias current I_{B2} may increase as the negative voltage Vs− drops. Accordingly, the gate bias voltage Vg may drop at a rate lower than a drop rate of the negative voltage Vs−. The operating point current Iout of the amplifier transistor Q1 may change in proportion to the gate bias voltage Vg. As a result, the operating point current Iout of the amplifier transistor Q1 may be controlled to change with a smaller fluctuation than the negative voltage Vs− by the bias circuit 110. Additionally, a current variation ΔI′ of the operating point current Iout of the amplifier transistor Q1 may further decrease compared to the current variation AI shown in FIG. 3.

According to the above-mentioned embodiments of the present invention, a bias circuit supplying stable voltage and current to a transistor under a changing condition of temperature and supply voltage is provided.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

1. A bias circuit comprising:
a first resistor connected between a ground terminal and a first node;
a first bias transistor having a drain connected to the first node and a source connected to a second node;
a second bias transistor having a drain connected to the second node and a source connected a negative voltage terminal;
a third bias transistor having a drain connected to the ground terminal and a source connected at a third node; and
a second resistor having a first end connected at the third node and a second end connected at the negative voltage terminal,
wherein a gate of the first bias transistor is connected to the second node,
wherein a gate of the second bias transistor is connected to the negative voltage terminal,
wherein a gate of the third bias transistor is connected to the first node, and
wherein a gate bias voltage signal is outputted through the third node.

2. The bias circuit of claim 1, further comprising a bias resistor having a first end connected at the third node and second end connected at a gate of an amplifier transistor.

3. The bias circuit of claim 1, wherein the first to third bias transistors are depletion transistors.

4. The bias circuit of claim 1, wherein a first bias current flowing in the first resistor is controlled by the first and second bias transistors.

5. The bias circuit of claim 4, wherein a gate voltage of the third bias transistor is controlled by the first resistor and the first bias current.

6. The bias circuit of claim 1, wherein a second bias current flowing in the second resistor is controlled by the third bias transistor.

7. The bias circuit of claim 6, wherein the gate bias voltage is controlled by the second resistor and the second bias current.

8. The bias circuit of claim 1, further comprising:
an amplifier transistor having a gate connected to the third node.

9. The bias circuit of claim 8, further comprising:
wherein a gate bias voltage of the gate bias voltage signal changes according to a temperature change; and
wherein an operating point current of the amplifier transistor is maintained constantly regardless of the temperature change.

10. The bias circuit of claim 1, further comprising:
wherein a second bias current flows between the third node and the negative voltage terminal through the second resistor, and
wherein a gate bias voltage of the gate bias voltage signal is determined by the second resistor and the second bias current.

11. The bias circuit of claim 10, wherein the gate bias voltage changes at a rate lower than a change rate of the negative voltage Vₛ−.

12. The bias circuit of claim 11, further comprising:
an amplifier transistor having a gate connected to the third node; and
wherein an operating point current of the amplifier transistor changes in proportion to the gate bias voltage and with a smaller fluctuation than the negative voltage Vₛ−.
